(19) United States
(12) Patent Application Publication
(10) Pub. No.: US 2015/0088598 A1
(43) Pub. Date: Mar. 26, 2015

(54) CROSS-RETAIL MARKETING BASED ON ANALYTICS OF MULTICHANNEL CLICKSTREAM DATA

(71) Applicant: INTERNATIONAL BUSINESS MACHINES CORPORATION, Armonk, NY (US)

(72) Inventors: Ajoy Acharyya, Kolkata (IN); AJAY KUMAR BEHURIA, Bentonville, AR (US); James E. Bostick, Cedar Park, TX (US); John M. Ganci, JR., Cary, NC (US); Tanambam D. Sinha, Kolkata (IN); Craig M. Trim, Sylmar, CA (US)

(73) Assignee: INTERNATIONAL BUSINESS MACHINES CORPORATION, Armonk, NY (US)

(21) Appl. No.: 14/034,649

(22) Filed: Sep. 24, 2013

(51) Int. Cl. G06Q 30/00

(52) U.S. Cl. CPC G06Q 30/00
USPC 705/7.29

(57) ABSTRACT

A method and associated system of cross-retail marketing based on analysis of multichannel clickstream data that comprises a client application capturing, aggregating, and analyzing multiple clickstreams of a user. These clickstreams may be captured from multiple unrelated or competing sales or distribution channels and from multiple electronic platforms. The analysis may use methods of artificial intelligence, text analytics, semantic analytics, or other analytical methods to infer characteristics of the user, of the user's online commercial behavior and other commercial activities, and of products or services that the user may be interested in purchasing. The output of this analysis is forwarded to other channels or platforms visited by the user in order to allow those other channels or platforms to perform targeted commercial marketing functions related to the user's prior activities. In preferred embodiments, this method may be require an active consent or other authorization from the user.

### TECHNICAL FIELD

The present invention relates to analyzing customer buying behavior.

### BACKGROUND

An Internet advertiser or merchant may record a user's online activities, such as the user's browsing history, mouse clicks, or keystrokes, and then use that recorded information to predict the user's future behavior or to more precisely target advertising to the user. Such a “clickstream analysis,” however, is limited to user activities within a specific domain that is under the control of the advertiser or merchant, such as the advertiser's or merchant's Web site. There is no straightforward, generally accepted, way to capture, synchronize, and aggregate information associated with real-time online customer behavior that occurs across multiple unrelated or competing channels, such as social-media sites, search engines, and retailer Web sites.

### BRIEF SUMMARY

A first embodiment of the present invention provides a method for cross-retail marketing, the method comprising:

a processor of a computer system collecting clickstream data generated by a plurality of commercial activities of a user, wherein the commercial activities take place in a plurality of sales channels;

the processor aggregating, organizing, and analyzing the collected clickstream data in order to infer a characteristic of the user or a characteristic of a product associated with an activity of the plurality of commercial activities;

the processor responding to a further activity of the user, wherein the user performs the activity in an additional sales channel, by forwarding the inferred characteristic to a marketing tool associated with the additional sales channel, and wherein the additional sales channel is distinct from any sales channel of the plurality of sales channels.

A second embodiment of the present invention provides a computer program product, comprising a computer-readable hardware storage device having a computer-readable program code stored therein, said program code configured to be executed by a processor of a computer system to implement a method for cross-retail marketing, the method comprising:

the processor collecting clickstream data generated by a plurality of commercial activities of a user, wherein the commercial activities take place in a plurality of sales channels;

the processor aggregating, organizing, and analyzing the collected clickstream data in order to infer a characteristic of the user or a characteristic of a product associated with an activity of the plurality of commercial activities;

the processor responding to a further activity of the user, wherein the user performs the activity in an additional sales channel, by forwarding the inferred characteristic to a marketing tool associated with the additional sales channel, and wherein the additional sales channel is distinct from any sales channel of the plurality of sales channels.

A third embodiment of the present invention provides a computer system comprising a processor, a memory coupled to said processor, and a computer-readable hardware storage device coupled to said processor, said storage device containing program code configured to be run by said processor via the memory to implement a method for cross-retail marketing, the method comprising:

the processor collecting clickstream data generated by a plurality of commercial activities of a user, wherein the commercial activities take place in a plurality of sales channels;

the processor aggregating, organizing, and analyzing the collected clickstream data in order to infer a characteristic of the user or a characteristic of a product associated with an activity of the plurality of commercial activities;

the processor responding to a further activity of the user, wherein the user performs the activity in an additional sales channel, by forwarding the inferred characteristic to a marketing tool associated with the additional sales channel, and wherein the additional sales channel is distinct from any sales channel of the plurality of sales channels.

### BRIEF DESCRIPTION OF THE DRAWINGS

FIG. 1 shows the structure of a computer system and computer program code that may be used to implement a method of cross-retail marketing based on analytics of multichannel clickstream data in accordance with embodiments of the present invention.

FIG. 2 is a flow chart that illustrates steps of a method of cross-retail marketing based on analytics of multichannel clickstream data in accordance with embodiments of the present invention.

FIG. 3 shows one possible embodiment of step 203 of FIG. 2, in which structured and unstructured data received from multiple data sources is aggregated and processed by an analytics engine to produce structured output.

### DETAILED DESCRIPTION

An Internet merchant may deliver targeted marketing, such as a banner ad, coupon, or product suggestion, to a user, where that delivery is a function of the user's prior, current, or anticipated online activity. The merchant may capture or record characteristics of prior or current activities as a “clickstream” record of the user's menu choices, online searches, data entries, page views, and other online actions.

Here, clickstream data is defined as an electronic record of a user's activity collected from one or more nonportable, portable, and mobile computers, electronic consoles, other communications means, tablets, cell phones, media players, settop boxes, other electronic devices, and other electronic media, including the Internet and other networked computing environments.

The user may have performed these recorded activities in association with resources that may comprise, but are not limited to, unrelated or competing merchant Web sites, social-media Internet sites, other social-media resources or services, search engines, other online portals, mobile-device apps, Internet browsers, blogs or blog postings, Twitter feeds, the user's browsing, research, shopping, purchase, and purchase-feedback histories, GPS-derived and other location data, collaboration data, bookmarks or Favorite selections, cookies and other tracking files, Web-page source code, shopping-cart activities, a user's reading of or posting of online reviews and other comments, inferences of the user's hobbies and interests, and other online and offline online resources.

The present invention may further comprise an other electronic or nonelectronic resource in which a user's activities may be tracked, and may comprise, but is not limited to, a Web site, a Web portal, a brick-and-mortar retail establishment, an RFID device, or an electronic roadway toll-collection means.

A merchant may capture such a clickstream only when the merchant has authority or other legitimate ability to track the user's interactions on the online venue, portal, electronic platform, or other online resource where the user's activities take place. A retailer may, for example, be barred by legal, contractual, or technical means from monitoring a user's activities on a competitor's Web site.

Embodiments of the present invention address this issue by allowing a user to authorize a local software application to track the user's clickstreams on online venues, portals, platforms, and other online resources, regardless of which entity controls or manages those resources. Clickstreams gathered from these multiple sources may be aggregated, organized, and analyzed in real time, and a result of this analysis may describe characteristics of the user or of commercial products and entities with which the user may be associated.

When the user subsequently accesses another online resource, such as an independent manufacturer's Web site, the local software application may forward the result of the analysis to a component associated with the Web site, in order to allow the site to identify, generate, and deliver to the user targeted marketing. Such targeted marketing may be a function of clickstream data gathered from sources that would otherwise have been unavailable to the independent manufacturer.

In some embodiments, the local software application may comprise multiple software entities running on multiple platforms. Specialized programs may, for example, capture a user's clickstreams generated on a tablet, on a Windows PC, or on a mobile phone.

In some embodiments, one or more local applications may forward captured clickstreams to a server-side application that performs certain steps of the method of the present invention, where the certain steps may comprise further monitoring of the user's activities, aggregating multiple captured streams, analyzing the forwarded data, or communicating the results of the analysis to an online resource.

Embodiments of the present invention allow online merchants to apply technologies known to those skilled in the fields of analytics, e-commerce, online marketing, or artificial intelligence to infer information or otherwise analyze a user's clickstream data, where that clickstream data is collected from multiple sources and may comprise an aggregation of multiple clickstreams.

Consider, for example, a user who researches a product by reviewing prices and specifications on a first retailer's Web site, by reading product reviews on a consumer-feedback Web site, by following trending topics on Twitter, and by checking availability and shipping times at the Web site of an online distributer. Throughout the effort, an embodiment of the present invention tracks the user's clickstreams, recording, aggregating, organizing, synchronizing, and analyzing a cumulative record of the user's activities that are related to the product.

If the user launches a second, unrelated, retailer's Web site, that site may access and interpret the aggregated data in order to identify, create, or display targeted content associated with the product and with a characteristic of the user. That targeted content may comprise a banner ad, a demonstration video, a coupon, a menu of accessories or complementary products, or a discount offer. It may also comprise nondisplayed information that is used by an analytics engine or other computer software to analyze, characterize, or predict the user's behavior.

In a related example, consider a user who is an existing customer of the second retailer, where the second retailer specializes in photographic equipment. If the aggregated data reveals to the second retailer that the user, after booking a flight to Key West, Florida at a first Web site, subsequently entered search terms related to scuba diving into a search engine, the second retailer may respond by displaying to the user a banner ad announcing a sale on underwater camera gear. Furthermore, the advertisement could be further customized to better match the user's inferred needs by identifying sale dates related to the dates of the user's flight.

Unlike a clickstream-capturing mechanism that analyzes information captured from a single online resource or other source, the present invention captures clickstreams from multiple independent, unrelated, or even competing sources, organizes and aggregates the contents of the multiple captured clickstreams, and subjects the aggregated clickstream data to an analytical process that may synchronize, correlate, draw inferences, or otherwise identify relationships among data items captured from different sources. By sharing the results of this analysis with one or more other resources that may be directly or indirectly accessed by the user, the present invention may facilitate an effort by any of the other venues to identify and display targeted content to the user, even though the user may have no prior activity in that other resource.

In other embodiments, the present invention may share the results of its analysis with an electronic service that pushes targeted content to one or more resources used by the user, regardless of whether the user takes further action to directly or indirectly access any of the one or more other resources. In some embodiments, the one or more resources may comprise a mobile or handheld device, a resource that is not directly connected to the Internet, a resource that is not directly connected to an other network, a nonelectronic resource, or a resource that is not visible to the user.

Some embodiments of the present invention may perform these clickstream-capture, analysis, display, identification, push, and other functions only with the approval of the user. This approval may be specified as an opt-in approval, wherein the user must actively elect to consent to a function performed by the present invention, or as an opt-out approval, wherein the user is deemed to have tacitly consented to a function performed by the present invention unless the user actively indicates otherwise.

In some cases, this approval may be set globally by a mechanism that associates an approval with a user. In other cases, a user may be associated with multiple approvals or multiple levels of approval, where each approval or level of approval may be associated with a combination of distinct venues, distinct online resources, or other distinct resources, or may be associated as a function of a characteristic of a distinct venue, distinct online resource, or other distinct resource. Such a mechanism may allow the user a degree of control over when and how the user's clickstreams are tracked and used by an embodiment of the present invention. In some cases, a distinct type of consent may be associated with an approval or with a level of approval, where a distinct type of consent may comprise consent to perform only a certain combination of functions, or may comprise consent only if a certain condition is met.

Embodiments of the present invention may comprise arbitrary combinations of opt-in- and opt-out approvals, each of which may be associated with an arbitrary combination of conditions and each of which may be further associated with an arbitrary combination of functions that may be performed by the present invention. In a simple embodiment, a user's active opt-in consent may be deemed necessary to authorize the embodiment to track and analyze any activity of the user.

In some embodiments, a second retailer's use of data collected by the present invention from a first retailer may give the second retailer a competitive advantage over the first retailer. If, for example, an embodiment captures activities of a user who has been researching a particular model camera on a first retailer's site, a second retailer may automatically send the user's cell phone a text message offering an unboxed version of the same model at a steep discount. Although here the first retailer is placed at a disadvantage, this occurs because the second retailer is willing to provide the user a greater benefit. The user thus achieves an advantage by consenting to allow the embodiment of the present invention to capture the user's clickstreams. In some embodiments, the disadvantage to the first retailer may be mitigated if the invention further provides information to the first retailer about the second retailer's offer, or about the user's response to that offer.

In other words, embodiments of the present invention may provide value to users by allowing merchants to compete more effectively to serve the user's needs.

Some embodiments of the present invention may comprise two distinct classes of software working together. One or more client-side clickstream-tracking modules or agents may record a user's keystrokes and other activities on one or more platforms. One or more of these modules may further optionally aggregate, organize, or correlate the recorded information with other data, or may otherwise analyze or process the recorded information.

One or more server-side analysis modules may then receive some or all of this recorded or processed information, and these server-side entities may optionally further aggregate, organize, or otherwise analyze some or all of the received information. Such server-side modules may further correlate the received information with other information, such as a product description, externally stored historical data, or a demographic profile. The goal of these server-side activities is to help a merchant or other commercial entity identify a user's or a user-demographic's behavioral patterns, an other user characteristic, or an inferred intention (or “sentiment”) underlying a user activity, and to further help a merchant or other commercial entity identify appropriate means to respond to further user activities.

In some embodiments, client-side and server-side functions may be performed by a single distributed software entity. In other cases, a single software entity may coordinate or control distinct modules that perform some or all client-side and server-side functions. In yet other cases, all of these functions may be performed by only a client-side entity or by only a server-side entity.

Some embodiments will be able to identify and rank certain user activities or events or conditions that trigger certain user activities. Such identifying and ranking may be a function of parameters that may comprise, but are not limited to, a characteristic of a user, a characteristic of a prior activity, a characteristic of an industry, a product, a class of products, or a technology, a characteristic of a competitive action, and a characteristic of a communication, such as a text message, a posted review, an email, or a designating of a “friend,” “colleague,” or similar type of relationship on a social-media site.

In one example, an opt-in client-side clickstream filter and a server-side analysis module might collaboratively gather and identify an online user's behavioral data within one or more contexts. Examples of such contexts may comprise a context within which activities are performed on a social-media Web site, search activities are performed on a mobile device, or automated pricing comparisons for certain classes of products are requested by software running on a desktop computer.

Such an embodiment's opt-in client-side functionality might include gathering clickstream data from a plurality of sources, where such sources might include, but are not limited to, records of every Web site visited by the user, every Web page viewed by the user, the length of time that the user spent on each visited Web site or Web page, the order in which the user visited the sites or pages, a newsgroup in which the user participated, a characteristic of a banner advertisement that the user viewed or clicked through, a sequence of bids placed by the user in an online auction, and the user's history of online purchases of products and services.

This embodiment might then use this gathered information to generate a structured representation of the user's requirements, of a characteristic of a product or service that the user may want to purchase or license, of the current status of the user's shopping, research, or purchase effort, and of a prior interaction between the user and a merchant or other commercial entity. This embodiment might share this structured representation with one or more entities that are authorized by the embodiment or that satisfy some other condition in order to help those entities create targeted campaigns that span multiple portals, venues, channels, or other commercial entities or resources.

Embodiments of the present invention may comprise an intelligent client-side agent that, through authority of a user's opt-in selection, is allowed to collect data from sources that would otherwise be unavailable to a clickstream data-collecting application. While a traditional Web-crawling entity may discover general content of a Web site, such a Web-crawling entity may not be allowed access to password-protected content, dynamically generated content, or otherwise-hidden or restricted content that is visible only to an authorized user or only in response to an activity of the user. As described above, embodiments of the present invention may be authorized by a user through a consent mechanism to track a user's activities, as well as an online resource's response to the activities, even when the user's activities are associated with otherwise-restricted content.

The same is true for activities associated with content that may be available from distinct, unrelated, or competing online resources. Two competing merchants' Web sites, for example, may each comprise a distinct tracking mechanism that records characteristics of a user's activity on its own Web site, but is barred from doing so on its competitor's site. Embodiments of the present invention, however, may not be associated with either competing merchant, and may thus be authorized by means of the user's consent to track the user's activities on both competing sites. Such an embodiment may thus allow activities associated with unrelated or competing merchants to be aggregated, organized, correlated, and analyzed. With the user's consent, this analyzed information may then be made available to other merchants or providers of online or nonelectronic resources on which the user performs an activity or with which the user is otherwise associated.

The present invention thus facilitates the application of analytical techniques known to those skilled in the arts of analytics, data analysis, data mining, business intelligence, marketing, and related fields, to aggregated information sources that would otherwise be unavailable to a marketing application. Such analytics techniques may attempt to infer meanings and sentiments associated with tracked activities, thereby facilitating subtle and complex characterizations of a user's intent and allowing the development of real-time responses or granular market segmentation based on cross-market or multichannel customer behavior analysis, profiling, and personality parameters.

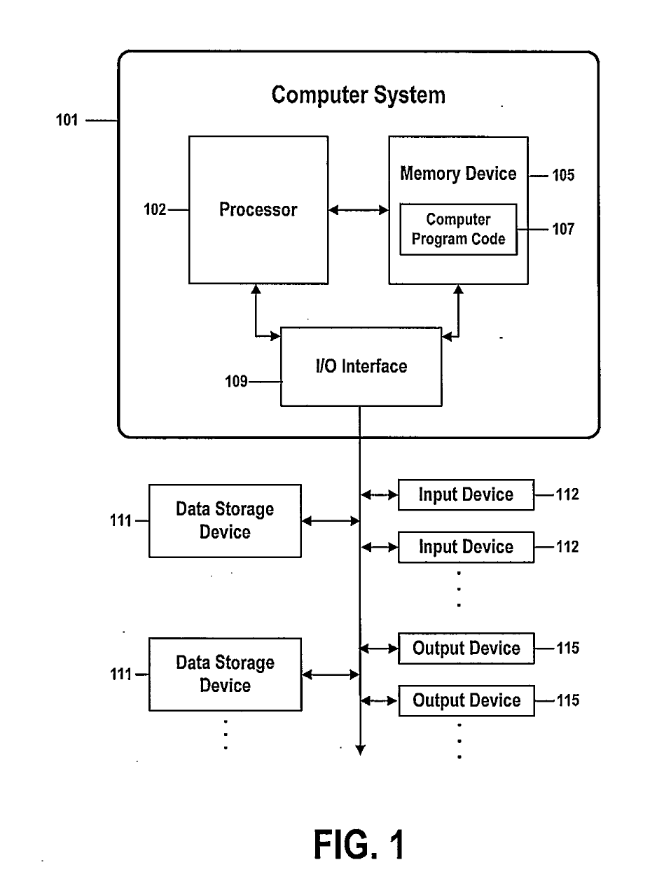

FIG. 1 shows a structure of a computer system and computer program code that may be used to implement a method of cross-retail marketing based on analytics of multichannel clickstream data in accordance with embodiments of the present invention. FIG. 1 refers to objects 101-115.

Aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module,” or “system.” Furthermore, in one embodiment, the present invention may take the form of a computer program product comprising one or more physically tangible (e.g., hardware) computer-readable medium(s) or devices having computer-readable program code stored therein, said program code configured to be executed by a processor of a computer system to implement the methods of the present invention. In one embodiment, the physically tangible computer readable medium(s) and/or device(s) (e.g., hardware media and/or devices) that store said program code, said program code implementing methods of the present invention, do not comprise a signal generally, or a transitory signal in particular.

Any combination of one or more computer-readable medium(s) or devices may be used. The computer-readable medium may be a computer-readable signal medium or a computer-readable storage medium. The computer-readable storage medium may be, for example, but is not limited to, an electronic, magnetic, optical, electromagnetic, infrared, or semiconductor system, apparatus, or device, or any suitable combination of the foregoing. More specific examples (a non-exhaustive list) of the computer-readable storage medium or device may include the following: an electrical connection, a portable computer diskette, a hard disk, a random access memory (RAM), a read-only memory (ROM), an erasable programmable read-only memory (EPROM or flash memory), Radio Frequency Identification tag, a portable compact disc read-only memory (CD-ROM), an optical storage device, a magnetic storage device, or any suitable combination of the foregoing. In the context of this document, a computer-readable storage medium may be any physically tangible medium or hardware device that can contain or store a program for use by or in connection with an instruction execution system, apparatus, or device.

A computer-readable signal medium may include a propagated data signal with computer-readable program code embodied therein, for example, a broadcast radio signal or digital data traveling through an Ethernet cable. Such a propagated signal may take any of a variety of forms, including, but not limited to, electro-magnetic signals, optical pulses, modulation of a carrier signal, or any combination thereof.

Program code embodied on a computer-readable medium may be transmitted using any appropriate medium, including but not limited to wireless communications media, optical fiber cable, electrically conductive cable, radio-frequency or infrared electromagnetic transmission, etc., or any suitable combination of the foregoing.

Computer program code for carrying out operations for aspects of the present invention may be written in any combination of one or more programming languages, including, but not limited to programming languages like Java, Smalltalk, and C++, and one or more scripting languages, including, but not limited to, scripting languages like JavaScript, Perl, and PHP. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN), a wide area network (WAN), an intranet, an extranet, or an enterprise network that may comprise combinations of LANs, WANs, intranets, and extranets, or the connection may be made to an external computer (for example, through the Internet using an Internet Service Provider).

Aspects of the present invention are described above and below with reference to flowchart illustrations and/or block diagrams of methods, apparatus (systems) and computer program products according to embodiments of the present invention. It will be understood that each block of the flowchart illustrations, block diagrams, and combinations of blocks in the flowchart illustrations and/or block diagrams of FIGS. 1-3 can be implemented by computer program instructions. These computer program instructions may be provided to a processor of a general purpose computer, special purpose computer, or other programmable data-processing apparatus to produce a machine, such that the instructions, which execute via the processor of the computer or other programmable data-processing apparatus, create means for implementing the functions/acts specified in the flowchart and/or block diagram block or blocks.

These computer program instructions may also be stored in a computer-readable medium that can direct a computer, other programmable data-processing apparatus, or other devices to function in a particular manner, such that the instructions stored in the computer-readable medium produce an article of manufacture, including instructions that implement the function/act specified in the flowchart and/or block diagram block or blocks.

The computer program instructions may also be loaded onto a computer, other programmable data-processing apparatus, or other devices to cause a series of operational steps to be performed on the computer, other programmable apparatus, or other devices to produce a computer-implemented process such that the instructions that execute on the computer or other programmable apparatus provide processes for implementing the functions/acts specified in the flowchart and/or block diagram block or blocks.

The flowchart illustrations and/or block diagrams FIGS. 1-3 illustrate the architecture, functionality, and operation of possible implementations of systems, methods and computer program products according to various embodiments of the present invention. In this regard, each block in the flowchart or block diagrams may represent a module, segment, or portion of code, wherein the module, segment, or portion of code comprises one or more executable instructions for implementing one or more specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special-purpose hardware-based systems that perform the specified functions or acts, or combinations of special-purpose hardware and computer instructions.

In FIG. 1, computer system 101 comprises a processor 103 coupled through one or more I/O Interfaces 109 to one or more hardware data storage devices 111 and one or more I/O devices 113 and 115.

Hardware data storage devices 111 may include, but are not limited to, magnetic tape drives, fixed or removable hard disks, optical discs, storage-equipped mobile devices, and solid-state random-access or read-only storage devices. I/O devices may comprise, but are not limited to: input devices 113, such as keyboards, scanners, handheld telecommunications devices, touch-sensitive displays, tablets, biometric readers, joysticks, trackballs, or computer mice; and output devices 115, which may comprise, but are not limited to printers, plotters, tablets, mobile telephones, displays, or sound-producing devices. Data storage devices 111, input devices 113, and output devices 115 may be located either locally or at remote sites from which they are connected to I/O Interface 109 through a network interface.

Processor 103 may also be connected to one or more memory devices 105, which may include, but are not limited to, Dynamic RAM (DRAM), Static RAM (SRAM), Programmable Read-Only Memory (PROM), Field-Programmable Gate Arrays (FPGA), Secure Digital memory cards, SIM cards, or other types of memory devices.

At least one memory device 105 contains stored computer program code 107, which is a computer program that comprises computer-executable instructions. The stored computer program code includes a program that implements a method of cross-retail marketing based on analytics of multichannel clickstream data in accordance with embodiments of the present invention, and may implement other embodiments described in this specification, including the methods illustrated in FIGS. 1-3. The data storage devices 111 may store the computer program code 107. Computer program code 107 stored in the storage devices 111 is configured to be executed by processor 103 via the memory devices 105. Processor 103 executes the stored computer program code 107.

Thus the present invention discloses a process for supporting computer infrastructure, integrating, hosting, maintaining, and deploying computer-readable code into the computer system 101, wherein the code in combination with the computer system 101 is capable of performing a method of cross-retail marketing based on analytics of multichannel clickstream data.

Any of the components of the present invention could be created, integrated, hosted, maintained, deployed, managed, serviced, supported, etc. by a service provider who offers to facilitate a method of cross-retail marketing based on analytics of multichannel clickstream data. Thus the present invention discloses a process for deploying or integrating computing infrastructure, comprising integrating computer-readable code into the computer system 101, wherein the code in combination with the computer system 101 is capable of performing a method of cross-retail marketing based on analytics of multichannel clickstream data.

One or more data storage units 111 (or one or more additional memory devices not shown in FIG. 1) may be used as a computer-readable hardware storage device having a computer-readable program embodied therein and/or having other data stored therein, wherein the computer-readable program comprises stored computer program code 107. Generally, a computer program product (or, alternatively, an article of manufacture) of computer system 101 may comprise said computer-readable hardware storage device.

While it is understood that program code 107 for cross-retail marketing based on analytics of multichannel clickstream data may be deployed by manually loading the program code 107 directly into client, server, and proxy computers (not shown) by loading the program code 107 into a computer-readable storage medium (e.g., computer data storage device 111), program code 107 may also be automatically or semi-automatically deployed into computer system 101 by sending program code 107 to a central server (e.g., computer system 101) or to a group of central servers. Program code 107 may then be downloaded into client computers (not shown) that will execute program code 107.

Alternatively, program code 107 may be sent directly to the client computer via e-mail. Program code 107 may then either be detached to a directory on the client computer or loaded into a directory on the client computer by an e-mail option that selects a program that detaches program code 107 into the directory.

Another alternative is to send program code 107 directly to a directory on the client computer hard drive. If proxy servers are configured, the process selects the proxy server code, determines on which computers to place the proxy servers' code, transmits the proxy server code, and then installs the proxy server code on the proxy computer. Program code 107 is then transmitted to the proxy server and stored on the proxy server.

In one embodiment, program code 107 for cross-retail marketing based on analytics of multichannel clickstream data is integrated into a client, server and network environment by providing for program code 107 to coexist with software applications (not shown), operating systems (not shown) and network operating systems software (not shown) and then installing program code 107 on the clients and servers in the environment where program code 107 will function.

The first step of the aforementioned integration of code included in program code 107 is to identify any software on the clients and servers, including the network operating system (not shown), where program code 107 will be deployed that are required by program code 107 or that work in conjunction with program code 107. This identified software includes the network operating system, where the network operating system comprises software that enhances a basic operating system by adding networking features. Next, the software applications and version numbers are identified and compared to a list of software applications and correct version numbers that have been tested to work with program code 107. A software application that is missing or that does not match a correct version number is upgraded to the correct version.

A program instruction that passes parameters from program code 107 to a software application is checked to ensure that the instruction's parameter list matches a parameter list required by the program code 107. Conversely, a parameter passed by the software application to program code 107 is checked to ensure that the parameter matches a parameter required by program code 107. The client and server operating systems, including the network operating systems, are identified and compared to a list of operating systems, version numbers, and network software programs that have been tested to work with program code 107. An operating system, version number, or network software program that does not match an entry of the list of tested operating systems and version numbers is upgraded to the listed level on the client computers and upgraded to the listed level on the server computers.

After ensuring that the software, where program code 107 is to be deployed, is at a correct version level that has been tested to work with program code 107, the integration is completed by installing program code 107 on the clients and servers.

Embodiments of the present invention may be implemented as a method performed by a processor of a computer system, as a computer program product, as a computer system, or as a processor-performed process or service for supporting computer infrastructure.

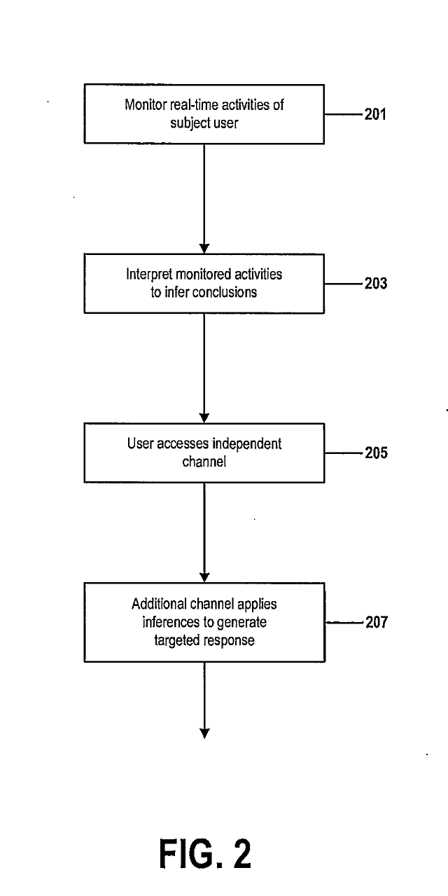

FIG. 2 is a flow chart that illustrates steps of a method of cross-retail marketing based on analytics of multichannel clickstream data in accordance with embodiments of the present invention. FIG. 2 comprises steps 201-207.

In Step 201 an embodiment of the present invention tracks the activities of a subject user. These activities may comprise, but are not limited to, making an online purchase; requesting online support; viewing information about a product or service; clicking a hyperlink; forwarding a hyperlink or online-resource address; adding, removing, or editing an item in an electronic shopping basket or cart; posting or forwarding a comment, review, Twitter feed, or other message; playing a video; registering for a webinar or other event; listening to a podcast; downloading content; responding to an offer; performing a search; reading a review; and any other online or offline activity that may be monitored by embodiments of the present invention.

In some embodiments, this tracking may require one or more approvals or consents from the user. In some embodiments, this tracking may require one or more approvals or consents from all or a subset of the tracked venues, portals, services, channels, or other resources associated with the tracked activities.

In some embodiments, this tracking may be performed by one or more client applications running on one or more of the user's local devices. In some embodiments, such a client application may be associated with a Web browser, a cloud-computing application, a program that originated from a tracked or untracked venue, portal, service, channel, or other resource, a program or other means comprised by an embodiment of the present invention, or combinations thereof. In some embodiments, the tracking may be performed by one or more applications running on a remote platform, such as the Internet, on a cloud-computing platform, on one or more of the tracked venues, portals, services, channels, or other tracked resources.

In some embodiments, the tracking may be performed by one or more combinations of any of these means. Selection of such combinations may be a function of a characteristic of: the user or of another person or entity associated with the user; of a tracked activity; of a resource associated with either the user or with an activity; of a time of day, day of week, or day of a year; or combinations thereof.

Embodiments of the present invention may comprise a single tracking means to track all of a user's activities that fall within the scope of the particular embodiment. Other embodiments may comprise a series of means selected from a plurality of candidate means, where the selecting is a function of a type of tracked activity, of a platform upon which the user performs an activity, of a platform related to a resource associated with an activity resides, of some other contextual factor, or of combinations thereof.

The user may be anonymous to some embodiments of the present invention; may be identified by a characteristic that comprises no personally identifying information; or may be identified by a true name, address, zip code, or other true information. In some embodiments, a user may be identified by a pseudonym or a user-selected name, address, zip code, or other pseudonymous identifier; by an IP address; by an other hardware or software serial number, activation code, or other identifying number; or by some combination of identifiers that may comprise one or more elements of personally identifying information.

Embodiments of the present invention may allow a user to select a combination of any of these types of identifiers, or to indirectly select a combination by identifying a condition or characteristic, such as a class of authorized tracking activities, a security level associated with the user, a security level associated with both the user and with a class of tracking activities, or an other combination of conditions and characteristics of the user, of the user's activities, and of resources associated with the user or with the activities.

In step 203, embodiments aggregate, organize, and analyze the information tracked in step 201, in order to infer meaning to the user's tracked activities. In some embodiments, this procedure comprises an application of a technique or technology known to those skilled in the field of text analytics or of semantic analytics.

In some embodiments, the procedure of step 203 may identify or imply one or more characteristics of the user that may comprise, but are not limited to: a demographic quality of the user; a pattern of previous buying, shopping, research, or product-usage behavior; a user product or service preference, such as a preference for brand-name or generic products; a level of technical or nontechnical skill; a shopping preference, such as a preference to purchase products at a brick-and-mortar outlet after researching the product online or a tendency to engage in impulse buying; a propensity to purchase after-market products, to be upsold, or to mix products from different vendors; brand loyalties; and likelihood to be influenced by a particular online resource, such as a social-media service, vendor literature, retailer literature, current events, colleagues or friends in a social network, or a specific product-review site.

Many other characteristics may be identified or inferred by step 203, using techniques known to those skilled in the relevant arts. In some embodiments, such characteristics may further comprise a combination of physical attributes, personality traits, patterns of behavior, a pattern of adherence or nonadherence to cultural and social patterns of consumption, or other types of data about the user's needs or about a product associated with the user that may be directly or indirectly inferred from a record of the tracked activities.

In some embodiments, the procedure of step 203 may be a further function of information comprised by a product catalog that describes one or more characteristics of one or more products or services associated with an activity of the user. Such one or more characteristics may comprise, but are not limited to, availability, local availability, list price, selling price, local selling price, availability of local shipping methods, shipping costs, delivery times, existence and cost of generic equivalents, availability of pre-owned units, and resale values.

In some embodiments, the procedures of step 203 are performed in real-time, such that a characteristic of a user activity is captured and analyzed as it is performed by the user. In other embodiments, the characteristic may be captured in real-time by a first software component, but analyzed by a second, distinct, component acting either concurrently or sequentially in relation to the first component. In the latter case, the two software components, working together, may provide output with real-time or near real-time performance, where such performance implies that the results of the procedures of step 203 will be available, within a timespan brief enough to be unnoticed by the user, to an other venue, portal, or channel when the user attempts to access the other venue, portal, or channel.

In step 205, the user accesses an additional venue, portal, channel, or other resource, where that additional venue, portal, channel or other resource may be unrelated to any of the user's prior activities. This additional venue, portal, channel or other resource may, as described above, be a computerized or noncomputerized sales channel, online resource, or other instrumentality of commerce capable of interpreting information gathered in step 201 or an inference or conclusion identified in step 203. In some embodiments, this resource may be a bricks-and-mortar physical retail sales outlet or other sales or marketing instrumentality, such as a kiosk or sales person equipped with a means of receiving and interpreting information identified in step 203. In some embodiments, this resource or sales channel may comprise a nonportable, portable, or mobile electronic computing device; an electronic console; an electronic telecommunications mechanism; an other consumer-electronics device; a brick-and-mortar retail outlet; an other type of passive electronic shopping device; and an other type of interactive electronic shopping device.

In step 207, embodiments of the present invention forward to the additional venue, portal, channel, or other resource information gathered in step 201 or an inference or conclusion identified in step 203. The additional venue, portal, channel, or other resource uses this forwarded information or inference to generate a targeted response to a user activity, where that user activity may comprise launching a Web site, clicking a hyperlink, selecting a menu entry, entering data into a form, viewing displayed content, or performing some other activity associated with the additional venue, portal, channel, or other resource.

As described above, this generated targeted response may comprise, but is not limited to, a banner ad, a video, a coupon, a menu of accessories or products complementary to a particular product, a discount offer, a push notification, an email or text message, a postal mailing, a telemarketing call, or an other type of targeted commercial content associated with a prior activity of the user. In some cases, the generated targeted response may comprise multiple responses on more than one platform or in more than one channel. In some cases, the generated targeted response may in turn be associated with further responses on or by the same or different platforms, portals, venues, sales, marketing, or distribution channels, other resources, or other means. In this document, a sales, marketing, or distribution channel may comprise a plurality of platforms that may include, but are not limited to, a terrestrial telephone, a smartphone, a tablet, a Web browser running on a desktop or notebook computer, a brick-and-mortar retail outlet, a Twitter account, an other social-media service, a direct mailing, a means of public solicitation or advertising, a feedback request, or a survey.

Some embodiments may also track the user's activities on the additional venue, portal, channel, or other resource and incorporate this tracked information into a procedure of aggregation, organization, and analysis similar to that of step 203. In such a case, the result of this analysis may be returned to the additional venue, portal, channel, or other resource with real-time or near real-time response in order to allow the additional venue, portal, channel, or other resource to further respond to the user's ongoing activities. This method of tracking, analyzing, and forwarding results may be repeated every time the user accesses yet an other additional venue, portal, channel, or other resource.

In some cases, an embodiment of the present invention may have already tracked a prior activity of the user on the additional venue, portal, channel, or other resource and may include that prior activity in an analytical procedure of step 203. In such a case, the targeted response may be a function of both the prior activity and of other activities tracked in step 201 that take place on or are associated with venues, portals, channels, or other resources distinct from the additional venue, portal, channel, or other resource.

Methods in conformance with embodiments of the present invention may comprise other variations of the method of FIG. 2. Examples cited in this document are for illustrative purposes only and are not meant to limit embodiments of the present invention to characteristics specific to those examples.

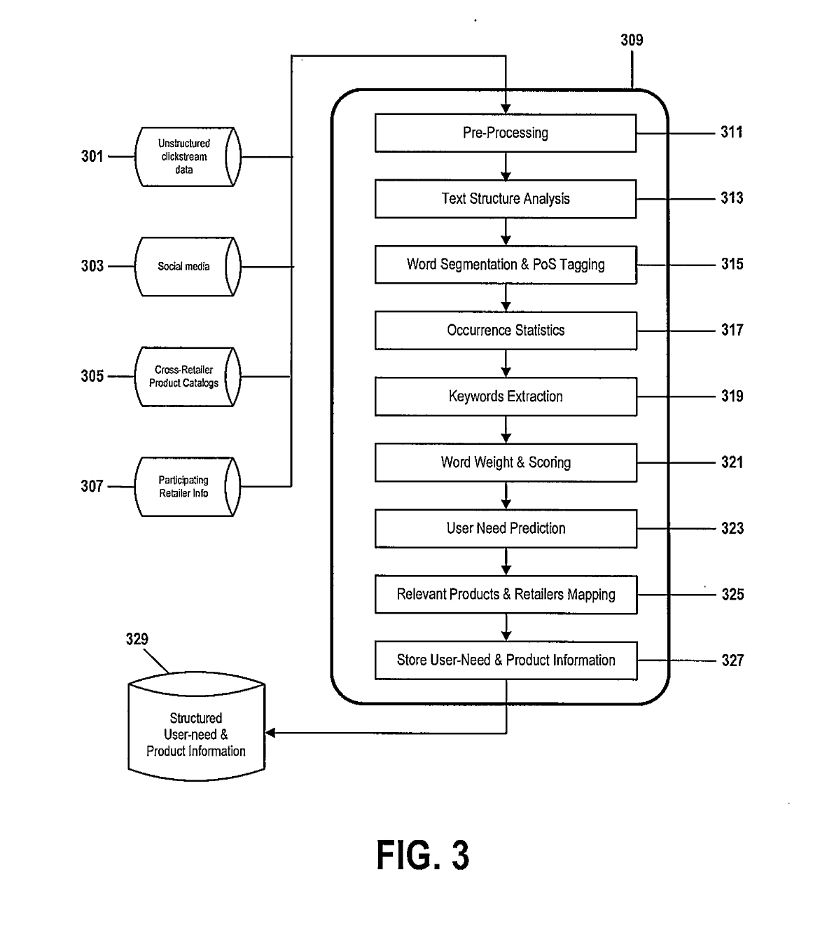

FIG. 3 shows an embodiment of the analytical process of step 203 of FIG. 2. FIG. 3 comprises items 301-329.

As illustrated in FIG. 2, embodiments of the present invention may aggregate, organize, and analyze the information tracked in step 201, in order to infer meaning to the user's tracked activities. In some embodiments, this procedure comprises an application of techniques or technology known to those skilled in the field of text analytics or of semantic analytics.

FIG. 3 illustrates a workflow in which a novel sequence of analytics techniques are used to process the collected clickstream data and other data collected in step 201 of FIG. 2. Although each of the techniques illustrated in steps 311-327 are known to those skilled in the art of analytics, electronic marketing, or data analysis, this particular combination and the manner in which it is applied is unique. The procedure of steps 311-327 are intended to merely illustrate one possible set of analytic procedures that may be performed by step 203 and are not meant to limit the types of analytical procedures that may be comprised by embodiments of the present invention.

FIG. 3 shows a workflow in which structured and unstructured data received from data sources 301-307 is aggregated and processed by an analytics engine 309 to produce structured output 329. Here, analytics engine 309 comprises analytics modules 311-327.

Data source 301 represents structured or unstructured descriptions of user online activities, where those descriptions are collected from one or more clickstream collectors or other types of client-side software applications, as described above.

Data source 303 represents social media Web sites, mobile-device apps, and other software entities that collect information about user activities associated with social media services and resources.

Data source 305 represents one or more cross-retailer product catalogs, which may contain information about products or services associated with a tracked user or an activity of a tracked user.

Data source 307 represents one or more repositories of information about one or more retailers, other merchants, or other instrumentalities of commerce. In some embodiments, this data source may be constrained to entities that participate in a program or marketing effort associated with an embodiment of the present invention.

Information collected from data sources 301-307 is forwarded to the analytics engine 309, where it is processed, sequentially, by:
Pre-Processing module 311, which may perform operations like identifying a Web site identified in the forwarded information as a site of user activity, in order to filter out irrelevant data on that Web site;
Text Structure Analysis module 313, which may analyze the text entered by a user to identify objectives such as user product needs;
Word Segmentation & Part-of-Speech Tagging module 315, which may parse or otherwise analyze freeform text identified by the forwarded information, such as comments culled from a social media service, online product reviews, or text entered by the user during the performance of an activity;
Occurrence Statistics module 317, which may identify how many times a user performs an activity that satisfies a particular condition, such as clicking on a certain type of displayed text, visiting a certain type of Web site, or viewing information about a particular class of product;
Keywords Extraction module 319, which may identify specific products of interest or other meaningful keywords as a function of the analyses of modules 311-317, or as a function of other information sources, such as user demographic information, user connections on social-media sites, or user demographic information;
Word Weight & Scoring module 321, which may assign weights to keywords identified by module 319 based on embodiment-specific scoring methods in order to further identify key products or product attributes in which a user may be interested;
User Need Prediction module 323, which may predict a user's current or future requirements, needs, or interests based on the analysis of modules 311-321;
Relevant Products & Retailers Mapping module 325, which may map or otherwise coordinate other relevant forwarded information about retailers and products onto the results of modules 311-323, in order to facilitate functions like cross-selling, upselling, and cooperative marketing;
User-Need and Product-Information Storage module 327, which stores information identified by modules 311-325 about user needs and product interests in a structured format that may be used by other software modules, where those other software modules may be comprised by an embodiment of the present invention. A structured format may comprise any sort of structured data known to those skilled in the relevant arts, such as a relational database, a spreadsheet, a flat file, a knowledgebase, a schema, or an ontology.

The resulting structured data generated by module 327 is then stored on a storage medium 329. In some embodiments, information from data sources 301-307 may also be stored on storage medium 329 in order to facilitate further processing by downstream systems.

What is claimed is:

1. A method for cross-retail marketing, the method comprising:
a processor of a computer system collecting clickstream data generated by a plurality of commercial activities of a user, wherein the commercial activities take place in a plurality of sales channels;
the processor aggregating, organizing, and analyzing the collected clickstream data in order to infer a characteristic of the user or a characteristic of a product associated with an activity of the plurality of commercial activities;
the processor responding to a further activity of the user, wherein the user performs the activity in an additional sales channel, by forwarding the inferred characteristic to a marketing tool associated with the additional sales channel, and wherein the additional sales channel is distinct from any sales channel of the plurality of sales channels.

2. The method of claim 1, wherein the clickstream data comprises information selected from the group comprising a record of: a Web site visited by the user; a Web page viewed by the user; a duration of time that the user spends on a Web page or Web site; an order in which the user visits a series of Web sites and Web pages; a newsgroup or other online forum in which the user participated; a banner advertisement through which the user clicked; a bid placed by the user in an online auction; a comment posted online by the user about a product or service; and a product or service purchased by the user in an online transaction.

3. The method of claim 1, wherein all or part of the clickstream data is derived from a source selected from the group comprising: an online history of the user's browsing, research, shopping, purchase, or purchase-feedback activities; GPS-derived or other data that identifies a location of the user; a bookmark or Favorite selection of the user; a cookie or other tracking record; a blog or other online forum; a Web page's source code; an online shopping cart activity; the user's record of reading of or posting online reviews and other online comments; a record of the user's online social contacts; and a hobby or other interest of the user.

4. The method of claim 1, wherein a sales channel of the plurality of sales channels is implemented on one or more platforms chosen from the group comprising: a nonportable, portable, or mobile electronic computing device; an electronic console; an electronic telecommunications mechanism; an other consumer-electronics device; a brick-and-mortar retail outlet; an other type of passive electronic shopping device; and an other type of interactive electronic shopping device.

5. The method of claim 1, wherein the additional sales channel is unrelated by a common ownership, a common management, or an other commercial relationship or to any sales channel of the plurality of sales channels.

6. The method of claim 1, wherein the analyzing comprises methods selected from the group comprising methods of text analytics, methods of semantic analytics, and methods associated with the field of artificial intelligence.

7. The method of claim 1, wherein the analyzing comprises processing the clickstream data by performing the tasks of: filtering out an element of irrelevant data from the clickstream data, wherein the element is deemed irrelevant because the element is not required by other tasks comprised by the analyzing; interpreting the textual structure of collected data to infer a user objective; parsing freeform data of the clickstream data into a first structured format; selecting multiple occurrences of a user activity that satisfies a particular condition, wherein the multiple occurrences are identified by the clickstream data; identifying meaningful keywords comprised by the clickstream data as a function of the filtering, interpreting, parsing, and selecting; assigning one or more assigned weights to one or more of the identified meaningful keywords; assigning a score to a scored data element of the collected clickstream data as a function of an assigned weight of the one or more assigned weights; predicting a requirement by the user for a first product as a function of the score; predicting a requirement by the user for a second product by considering other information about retailers and products; and formatting the predicted user's product requirements and other product requirements into a second structured format.

8. The method of claim 1, wherein the collecting must be authorized by an active or opt-in consent of the user, but does not require a consent of an entity associated with a sales channel of the plurality of sales channels.

9. The method of claim 1, wherein the inferred characteristic of the user is selected from the group comprising: a context of the user's activity; a demographic characteristic of the user; a characteristic of a demographic group to which the user belongs; a pattern of the user's prior buying, shopping, research, or product-usage behavior; a product preference or a service preference of the user; a level of technical or nontechnical skill of the user; a shopping preference of the user; a likelihood of the user to be influenced by a particular online resource; a physical attribute of the user; a personality trait of the user relevant to a commercial activity; an identification of an other member of the user's social circle; and a pattern of the user's adherence or nonadherence to a norm of consumer activity.

10. The method of claim 9, wherein the inferred characteristic enables the additional sales channel to perform a function selected from the group comprising: determining a characteristic of the first product that the user wishes to purchase; identifying a likelihood that the user would purchase the second product as a function of the user's interest in the first product; identifying a step that the user has taken toward purchasing a first product; identifying a detail of an interaction between the user and a merchant not associated with the additional sales channel; identifying an other online shopper who is associated with the user; identifying a purchase history of the user; and identifying a purchase history of the other online shopper.

11. The method of claim 10, wherein the first product and the second product are competing products.

12. The method of claim 1, further comprising providing at least one support service for at least one of creating, integrating, hosting, maintaining, and deploying computer-readable program code in the computer system, wherein the computer-readable program code in combination with the computer system is configured to implement the collecting, aggregating, organizing, analyzing, and responding.

13. A computer program product, comprising a computer-readable hardware storage device having a computer-readable program code stored therein, said program code configured to be executed by a processor of a computer system to implement a method for cross-retail marketing, the method comprising:
the processor collecting clickstream data generated by a plurality of commercial activities of a user, wherein the commercial activities take place in a plurality of sales channels;
the processor aggregating, organizing, and analyzing the collected clickstream data in order to infer a characteristic of the user or a characteristic of a product associated with an activity of the plurality of commercial activities;
the processor responding to a further activity of the user, wherein the user performs the activity in an additional sales channel, by forwarding the inferred characteristic to a marketing tool associated with the additional sales channel, and wherein the additional sales channel is distinct from any sales channel of the plurality of sales channels.

14. The method of claim 13, wherein the collecting must be authorized by an active or opt-in consent of the user, but does not require a consent of an entity associated with a sales channel of the plurality of sales channels.

15. The method of claim 13, wherein the analyzing comprises processing the clickstream data by performing the tasks of: filtering out an element of irrelevant data from the clickstream data, wherein the element is deemed irrelevant because the element is not required by other tasks comprised by the analyzing; interpreting the textual structure of collected data to infer a user objective; parsing freeform data of the clickstream data into a first structured format; selecting multiple occurrences of a user activity that satisfies a particular condition, wherein the multiple occurrences are identified by the clickstream data; identifying meaningful keywords comprised by the clickstream data as a function of the filtering, interpreting, parsing, and selecting; assigning one or more assigned weights to one or more of the identified meaningful keywords; assigning a score to a scored data element of the collected clickstream data as a function of an assigned weight of the one or more assigned weights; predicting a requirement by the user for a first product as a function of the score; predicting a requirement by the user for a second product by considering other information about retailers and products; and formatting the predicted user's product requirements and other product requirements into a second structured format.

16. The method of claim 15, wherein the inferred characteristic of the user is selected from the group comprising: a context of the user's activity; a demographic characteristic of the user; a characteristic of a demographic group to which the user belongs; a pattern of the user's prior buying, shopping, research, or product-usage behavior; a product preference or a service preference of the user; a level of technical or nontechnical skill of the user; a shopping preference of the user; a likelihood of the user to be influenced by a particular online resource; a physical attribute of the user; a personality trait of the user relevant to a commercial activity; an identification of an other member of the user's social circle; and a pattern of the user's adherence or nonadherence to a norm of consumer activity; and wherein the inferred characteristic enables the additional sales channel to perform a function selected from the group comprising: determining a characteristic of the first product that the user wishes to purchase; identifying a likelihood that the user would purchase the second product as a function of the user's interest in the first product; identifying a step that the user has taken toward purchasing a first product; identifying a detail of an interaction between the user and a merchant not associated with the additional sales channel; identifying an other online shopper who is associated with the user; identifying a purchase history of the user; and identifying a purchase history of the other online shopper.

17. The method of claim 15, wherein the first product and the second product are competing products, and wherein the additional sales channel is unrelated by a common ownership, a common management, or an other commercial relationship or to any sales channel of the plurality of sales channels.

18. A computer system comprising a processor, a memory coupled to said processor, and a computer-readable hardware storage device coupled to said processor, said storage device containing program code configured to be run by said processor via the memory to implement a method for cross-retail marketing, the method comprising:
the processor collecting clickstream data generated by a plurality of commercial activities of a user, wherein the commercial activities take place in a plurality of sales channels;
the processor aggregating, organizing, and analyzing the collected clickstream data in order to infer a characteristic of the user or a characteristic of a product associated with an activity of the plurality of commercial activities;
the processor responding to a further activity of the user, wherein the user performs the activity in an additional sales channel, by forwarding the inferred characteristic to a marketing tool associated with the additional sales channel, and wherein the additional sales channel is distinct from any sales channel of the plurality of sales channels.

19. The method of claim 18, wherein the collecting must be authorized by an active or opt-in consent of the user, but does not require a consent of an entity associated with a sales channel of the plurality of sales channels.

20. The method of claim 18,
wherein the inferred characteristic of the user is selected from the group comprising: a context of the user's activity; a demographic characteristic of the user; a characteristic of a demographic group to which the user belongs; a pattern of the user's prior buying, shopping, research, or product-usage behavior; a product preference or a service preference of the user; a level of technical or nontechnical skill of the user; a shopping preference of the user; a likelihood of the user to be influenced by a particular online resource; a physical attribute of the user; a personality trait of the user relevant to a commercial activity; an identification of an other member of the user's social circle; and a pattern of the user's adherence or nonadherence to a norm of consumer activity; and wherein the inferred characteristic enables the additional sales channel to perform a function selected from the group comprising: determining a characteristic of the first product that the user wishes to purchase; identifying a likelihood that the user would purchase the second product as a function of the user's interest in the first product; identifying a step that the user has taken toward purchasing a first product; identifying a detail of an interaction between the user and a merchant not associated with the additional sales channel; identifying an other online shopper who is associated with the user; identifying a purchase history of the user; and identifying a purchase history of the other online shopper;
wherein the first product and the second product are competing products;
and wherein the additional sales channel is unrelated by a common ownership, a common management, or an other commercial relationship or to any sales channel of the plurality of sales channels.
